(19) United States
(12) Patent Application Publication
(10) Pub. No.: US 2008/0078705 A1
(43) Pub. Date: Apr. 3, 2008

(54) SHAKER WEDGE

(75) Inventors: Brian S. Carr, Burlington, KY (US); Marc Tagher, Walton, KY (US)

Correspondence Address: OSHA LIANG/MI, ONE HOUSTON CENTER, SUITE 2800, HOUSTON, TX, 77010, US

(73) Assignee: M-I LLC, Houston, TX (US)

(21) Appl. No.: 11/860,466

(22) Filed: Sep. 24, 2007

Related U.S. Application Data
(60) Provisional application No. 60/827,582, filed on Sep. 29, 2006.

(51) Int. Cl. B07B 1/49; B28B 13/06; C04B 40/00

(52) U.S. Cl. 209/403; 264/219; 264/334; 264/50; 264/82

(57) ABSTRACT

A wedging apparatus including an outer polygonal surface configured to secure a screen to a shaker, the outer polygonal surface having a bottom surface, a top surface opposite the bottom surface, and at least one end surface joining the top surface and the bottom surface, and an inner core defined by the outer polygonal surface, wherein the inner core defines a cavity is disclosed. A method of forming an apparatus for securing a screen to a shaker is disclosed, the method including forming a mold of a wedging apparatus configured to secure a screen to a shaker, wherein a shape of the mod is an inverse of an outer polygonal surface having a bottom surface, a top surface opposite the bottom surface, and at least one end surface joining the top surface and the bottom surface, and an inner core defined by the outer polygonal surface, wherein the inner core defines a cavity, injecting a liquid resin into the mold, allowing the liquid resin to solidify, and removing the wedging apparatus from the mold.

### CROSS-REFERENCE TO RELATED APPLICATIONS

This application, pursuant to 35 U.S.C. § 119(e), claims priority to U.S. Provisional Application Ser. No. 60/827,582, filed Sep. 29, 2006. That application is incorporated by reference in its entirety.

### BACKGROUND

1. Field of the Invention

The present disclosure relates generally to apparatuses for securing a shaker screen to a shaker. In particular, the present disclosure relates to wedging apparatuses and methods of forming wedging apparatuses.

2. Background Art

Oilfield drilling fluid, often called “mud,” serves multiple purposes in the industry. Among its many functions, the drilling mud acts as a lubricant to cool rotary drill bits and facilitate faster cutting rates. Typically, the mud is mixed at the surface and pumped downhole at high pressure to the drill bit through a bore of the drillstring. Once the mud reaches the drill bit, it exits through various nozzles and ports where it lubricates and cools the drill bit. After exiting through the nozzles, the “spent” fluid returns to the surface through an annulus formed between the drillstring and the drilled wellbore.

Drilling mud provides a column of hydrostatic pressure, or head, to prevent “blow out” of the well being drilled. This hydrostatic pressure offsets formation pressures thereby preventing fluids from blowing out if pressurized deposits in the formation are breached. Two factors contributing to the hydrostatic pressure of the drilling mud column are the height (or depth) of the column (i.e., the vertical distance from the surface to the bottom of the wellbore) itself and the density (or its inverse, specific gravity) of the fluid used. Depending on the type and construction of the formation to be drilled, various weighting and lubrication agents are mixed into the drilling mud to obtain the right mixture. Typically, drilling mud weight is reported in “pounds,” short for pounds per gallon. Generally, increasing the amount of weighting agent solute dissolved in the mud base will create a heavier drilling mud. Drilling mud that is too light may not protect the formation from blow outs, and drilling mud that is too heavy may over invade the formation. Therefore, much time and consideration is spent to ensure the mud mixture is optimal. Because the mud evaluation and mixture process is time consuming and expensive, drillers and service companies prefer to reclaim the returned drilling mud and recycle it for continued use.

Another significant purpose of the drilling mud is to carry the cuttings away from the drill bit at the bottom of the borehole to the surface. As a drill bit pulverizes or scrapes the rock formation at the bottom of the borehole, small pieces of solid material are left behind. The drilling fluid exiting the nozzles at the bit acts to stir-up and carry the solid particles of rock and formation to the surface within the annulus between the drillstring and the borehole. Therefore, the fluid exiting the borehole from the annulus is a slurry of formation cuttings in drilling mud. Before the mud can be recycled and re-pumped down through nozzles of the drill bit, the cutting particulates must be removed.

One type of apparatus used to remove cuttings and other solid particulates from drilling mud is commonly referred to in the industry as a “shale shaker.” A shale shaker, also known as a vibratory separator, is a vibrating sieve-like table upon which returning used drilling mud is deposited and through which substantially cleaner drilling mud emerges. Typically, the shale shaker is an angled table with a generally perforated filter screen bottom. Returning drilling mud is deposited at the top of the shale shaker. As the drilling mud travels down the incline toward the lower end, the fluid falls through the perforations to a reservoir below thereby leaving the solid particulate material behind. The combination of the angle of inclination with the vibrating action of the shale shaker table enables the solid particles left behind to flow until they fall off the lower end of the shaker table.

The above described apparatus is illustrative of one type of shale shaker known to those of ordinary skill in the art. In alternate shale shakers, the top edge of the shaker may be relatively closer to the ground than the lower end. In such shale shakers, the angle of inclination may require the movement of particulates in a generally upward direction. In still other shale shakers, the table may not be angled, thus the vibrating action of the shaker alone may enable particle/fluid separation. Regardless, table inclination and/or design variations of existing shale shakers should not be considered a limitation of the present disclosure.

Preferably, the amount of vibration and the angle of inclination of the shale shaker table are adjustable to accommodate various drilling mud flow rates and particulate percentages in the drilling mud. After the fluid passes through the perforated bottom of the shale shaker, it may either return to service in the borehole immediately, be stored for measurement and evaluation, or pass through an additional piece of equipment (e.g., a drying shaker, a centrifuge, or a smaller sized shale shaker) to remove smaller cuttings and/or particulate matter.

Because shale shakers are typically in continuous use, repair operations, and associated downtimes, need to be minimized as much as possible. Often, the filter screens of shale shakers, through which the solids are separated from the drilling mud, wear out over time and subsequently require replacement. Therefore, shale shaker filter screens are typically constructed to be quickly removable and easily replaceable. Generally, through the loosening of several bolts, the filter screen may be lifted out of the shaker assembly and replaced within a matter of minutes. While there are numerous styles and sizes of filter screens, they generally follow similar design.

Typically, filter screens include a perforated plate base upon which a wire mesh, and/or other perforated filter overlay, is positioned. The perforated plate base generally provides structural support and allows the passage of fluids therethrough. While many perforated plate bases are flat or slightly arched, it should be understood that perforated plate bases having a plurality of corrugated or pyramid-shaped channels extending thereacross may be used instead. Pyramid-shaped channels may provide additional surface area for the fluid-solid separation process while guiding solids along their length toward the end of the shale shaker from where they are disposed.

In some shale shakers, a fine screen cloth is used with the vibrating screen. The screen may have two or more overlying layers of screen cloth and/or mesh. Layers of cloth or mesh may be bonded together and placed over a support, supports, or a perforated or apertured plate. The frame of the vibrating screen is resiliently suspended or mounted upon a support and is caused to vibrate by a vibrating mechanism (e.g., an unbalanced weight on a rotating shaft connected to the frame). Each screen may be vibrated by vibratory equipment to create a flow of trapped solids on top surfaces of the screen for removal and disposal of solids. The fineness or coarseness of the mesh of a screen may vary depending upon mud flow rate and the size of the solids to be removed.

FIG. 1 shows a conventional shaker apparatus that includes a lower frame 12 and an upper basket 14. The shaker apparatus 10 may have a variety of shapes and configurations, but generally it is intended to receive solids-laden mud from a distribution box (not shown) into the basket 14 that is vibrated by a motor (not shown) relative to the frame 12. The basket 14 includes an upstream end 18, a downstream end 20, a back wall 22 at the upstream end 18, and two side walls 24. The downstream end 20 is open. In operation, drilling mud including suspended solids is poured into the basket 14 over the back wall 22 and onto screen 16. Once on the screen 16, the solids-laden mud is vibrated toward the downstream end 20, which causes the mud to pass through the screen 16 into a collection box (not shown), and out of the shaker apparatus 10 for further processing. The flow of the solids-laden mud is indicated at 25 in FIG. 1. The solids continue to be conveyed downstream on the screen 16 toward the open end 26 where they are either dropped onto another screen for further separation or discarded.

Screen 16 may be mounted in the basket 14 with wedges 30a that are hammered into place under wedge angles 32 that are welded to the inside of basket 14 at an angle corresponding to the angle of the wedge 30a. In this manner, the screens 16 were installed by placing a pre-tensioned screen 16 onto support rails (not shown) in basket 14. Once in place, a wedge 30a is placed on top of the pre-tensioned screen 16 under wedge angle 32 and then hammered into engagement with the wedge angle 32 to apply a downward force on the screen 16. Accordingly, contact between the screen 16 and the support rail (not shown) in basket 14 may be maintained.

Typically, wedges are formed by, for example, casting or compression molding. As known in the art, casting is a process by which a material is introduced into a mold while it is liquid, allowed to solidify in the shape of the mold, and then removed producing a fabricated part. Compression molding is a method in which molding material that is generally preheated is first placed in an open, heated mold cavity. The mold is closed with a top force or plug member, pressure is applied to force the material into contact with all mold areas, and heat and pressure are maintained until the molding material has cured. However, both of these manufacturing methods tend to be expensive.

Accordingly, there exists a need for a wedge for a shaker screen that is economically efficient in manufacturing and structurally robust to withstand the forces generated during installation.

### SUMMARY OF INVENTION

In one aspect, embodiments disclosed herein relate to a wedging apparatus including an outer polygonal surface configured to secure a screen to a shaker, the outer polygonal surface having a bottom surface, a top surface opposite the bottom surface, and at least one end surface joining the top surface and the bottom surface, and an inner core defined by the outer polygonal surface, wherein the inner core defines a cavity.

In another aspect, embodiments disclosed herein relate a method of forming an apparatus for securing a screen to a shaker, the method including forming a mold of a wedging apparatus configured to secure a screen to a shaker, wherein a shape of the mold is an inverse of an outer polygonal surface having a bottom surface, a top surface opposite the bottom surface, and at least one end surface joining the top surface and the bottom surface, and an inner core defined by the outer polygonal surface, wherein the inner core defines a cavity, injecting a liquid resin into the mold, allowing the liquid resin to solidify, and removing the wedging apparatus from the mold.

Other aspects and advantages of the invention will be apparent from the following description and the appended claims.

### BRIEF DESCRIPTION OF DRAWINGS

FIG. 1 is a perspective view of a conventional shaker screen system.

FIG. 2 is a side view of a shaker screen and wedging apparatus assembly in accordance with embodiments disclosed herein.

FIGS. 3A and 3B are perspective views of wedging apparatuses in accordance with embodiments disclosed herein.

FIG. 4A is a cross-sectional view of a wedging apparatus in accordance with embodiments disclosed herein. FIG. 4B is a perspective view of FIG. 4A in accordance with embodiments disclosed herein.

FIGS. 5A and 5B are cross-sectional views of wedging apparatuses in accordance with embodiments disclosed herein.

FIGS. 6A and 6B are cross-sectional views of wedging apparatuses in accordance with embodiments disclosed herein.

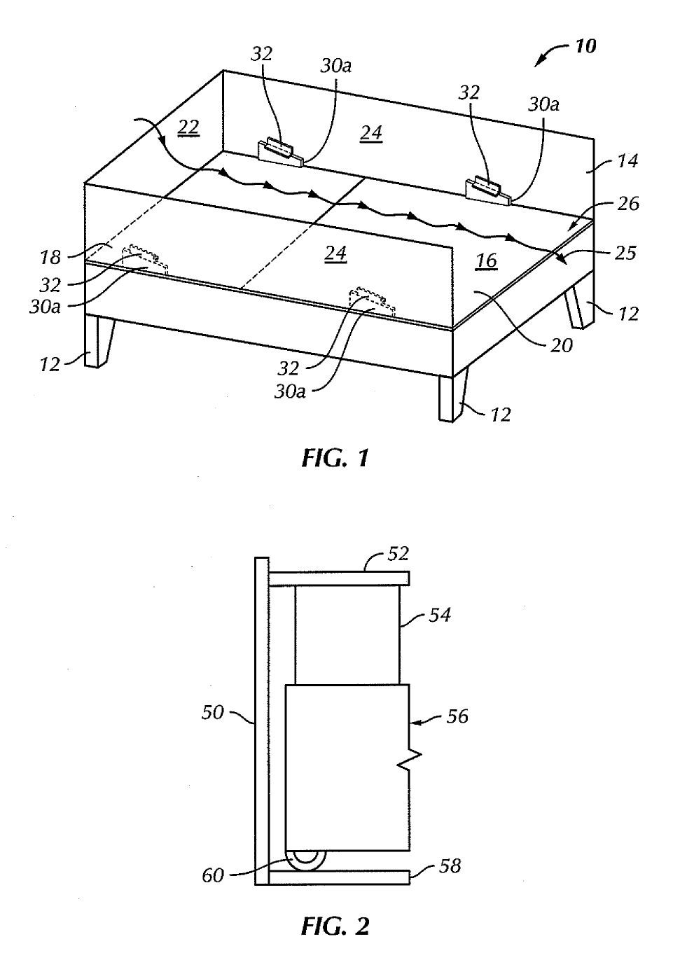

### DETAILED DESCRIPTION

In one aspect, embodiments disclosed herein relate to shale shakers. More specifically, embodiments disclosed herein relate to wedging apparatuses for securing screens to a shale shaker. In another aspect, embodiments disclosed herein relate to methods of forming a wedging apparatus.

FIG. 2 shows an end view of a shaker screen assembly in accordance with embodiments disclosed herein. In this embodiment, a wall 50 of a shaker basket is illustrated including a wedge bracket 52. A wedging apparatus 54 may be disposed between wedge bracket 52 and a shaker screen 56. Wedging apparatus 54 may include any generally polygonal shaped structure capable of applying compressive force on shaker screen 56 and a shaker basket perimeter or support rail 58. A sealing element 60 may be disposed between shaker screen 56 and support rail 58 to, for example, reduce leakage of drilling fluid and/or particulate matter therethrough.

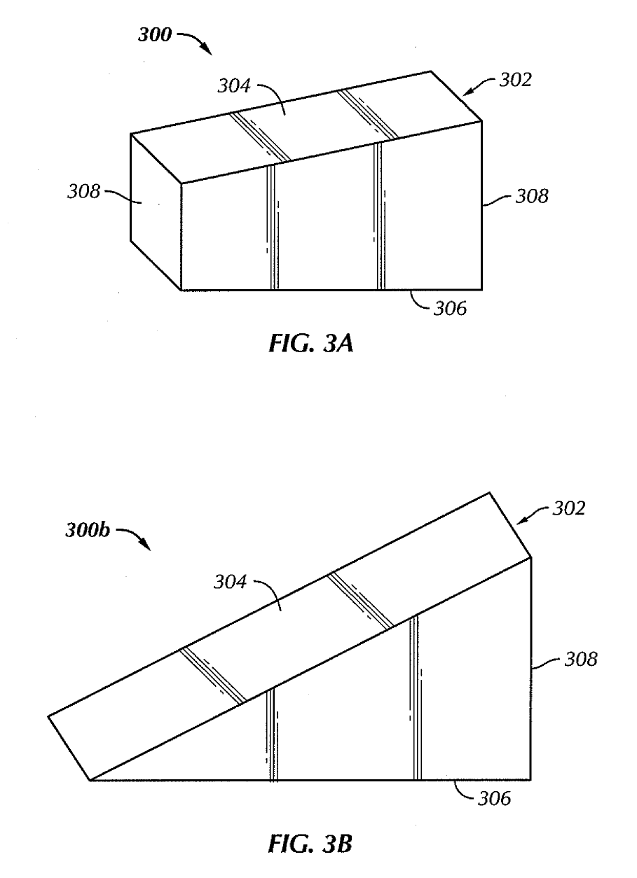

FIG. 3A shows a wedging apparatus 300 in accordance with embodiments disclosed herein. As shown, wedging apparatus 300 includes an outer polygonal surface 302 that includes a top surface 304, a bottom surface 306, and two end surfaces 308 joining top surface 304 and bottom surface 306. One of ordinary skill in the art will appreciate that wedging apparatus 300 may be any shape known in the art such that the wedging apparatus may wedge between two shaker components, thereby securing a screen. Referring briefly to FIG. 3B, in alternate embodiments, wedging apparatus 300b may include only one end surface 308, thereby forming a wedging apparatus 300b of a substantially triangular shape.

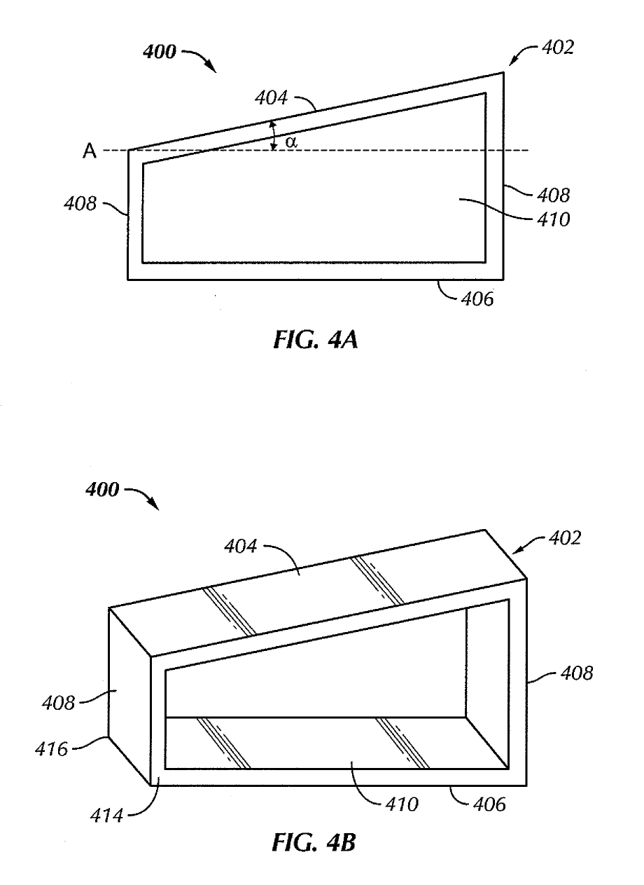

Referring now to FIG. 4A, a cross sectional view of a wedging apparatus 400 in accordance with embodiments disclosed herein is shown. Similar to wedging apparatus 300 in FIG. 3A, wedging apparatus 400 includes an outer polygonal surface 402 that includes a top surface 404, a bottom surface 406, and two end surfaces 408 that join top surface 404 and bottom surface 406.

Top surface 404 may be configured to slidably engage a wedge bracket (not shown) attached to an inside wall of a shaker basket (not shown). One of ordinary skill in the art will appreciate that the wedge bracket may be attached to the shaker basket at any angle to correspond with an angle of top surface 404. Accordingly, top surface 404 may be formed at any angle α with respect to horizontal axis A, as known in the art. For example, in one embodiment, the angle α of top surface 404 may be 0 degrees, 5 degrees, 30 degrees, 45 degrees, or any angle as known to one of ordinary skill in the art. In an alternate embodiment, top surface 404 may be formed at an angle of 0 degrees while bottom surface 406 may be formed at any angle with respect to a horizontal axis.

As shown, outer polygonal surface 402 defines an inner core 410. In one embodiment, as shown in FIG. 4B, inner core 410 may extend from a first side 414 though wedging apparatus 400 to a second side 416, thereby forming a cored wedging apparatus 400. Alternatively, first side 414 and second side 416 may substantially enclose inner core 410, thereby forming a hollow wedging apparatus (not independently illustrated). Accordingly, FIG. 4A may represent a cross-sectional view of a hollow and substantially enclosed wedging apparatus 400. Thus, inner core 410 defines a cavity (not independently illustrated). In some embodiments, the cavity may be filled, partially filled, traversed by ribs, or enclosed as described in greater detail below. In at least one embodiment, the cavity may be bisected to form two or more cavities.

Still referring to FIGS. 4A and 413, outer polygonal surface 402 may be formed from any material known in the art. For example, outer polygonal surface 402 may be formed from a plastic, such as polyurethane, polypropolene, or nylon. In an alternate embodiment, the polygonal surface 402 may be formed from a composite material, such as glass-filled polypropolene. With reference to the embodiments shown in FIGS. 4A and 4B, inner core 410 may be filled with any material known in the art. For example, inner core 410 may be filled with a material that provides structural rigidity to wedging apparatus 400. Alternatively, in one embodiment, inner core 410 may be filled with a plastic, such as, polyurethane, polypropolene, or nylon. In yet other embodiments, inner core 410 may be filled with a foam or gas.

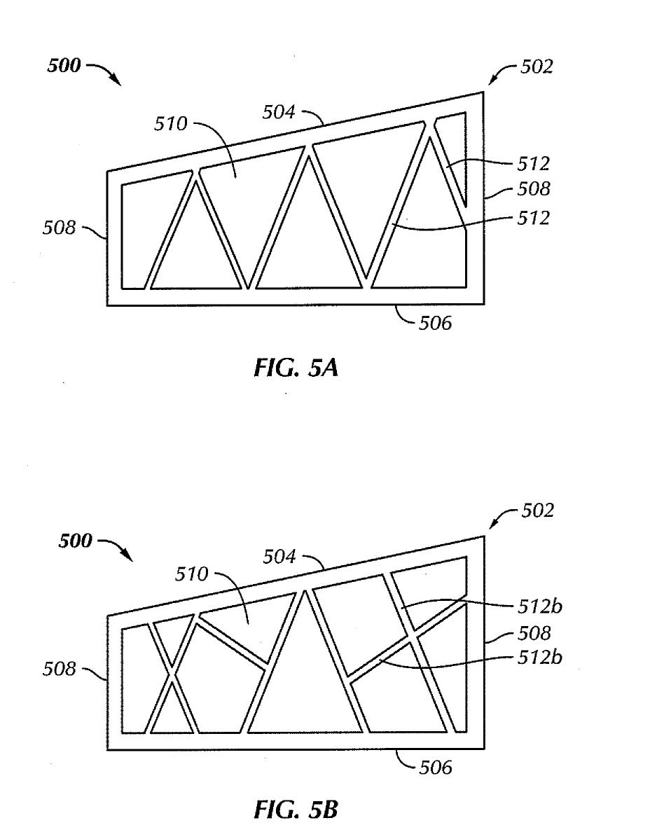

FIG. 5A shows a cross sectional view of a wedging apparatus 500 in accordance with embodiments disclosed herein. Wedging apparatus 500 includes an outer polygonal surface 502, including a top surface 504, a bottom surface 506, and two end surfaces 508 that join top surface 504 and bottom surface 506, thereby defining an inner core 510. A plurality of ribs 512 may be disposed within core 510 and may extend, for example, from top surface 504, bottom surface 506, or at least one end surface 508 to the bottom surface 506, at least one end surface 508, or top surface 504. Accordingly, in one embodiment, the plurality of ribs 512 may form a plurality of truss-like structures. Alternatively, in another embodiment, as shown in FIG. 5B, a plurality of ribs 512b may also extend between a first rib and a second rib or between a first rib and top surface 504, bottom surface 506, or end surface 508. In one embodiment, wedging apparatus 500 may include a first side (not shown) and/or a second side (not shown), wherein the first side joins a first edge of top surface 504 and a first edge of bottom surface 506, and the second side joins a second edge of top surface 504 and a second edge of bottom surface 506. Accordingly, first and second sides may enclose inner core 510.

In the embodiments shown in FIGS. 5A and 5B, plurality of ribs 512, 512b may be formed from any material known in the art. For example, plurality of ribs 512, 512b may be formed from a plastic, such as polyurethane, polypropolene, or nylon. In an alternate embodiment, plurality of ribs 512, 512b may be formed from a composite material, such as glass-filled polypropolene. Inner core 510 may be filled in and around the plurality of ribs 512, 512b with any material known in the art. In one embodiment, inner core 510 may be filled with a material that provides additional structural rigidity to the plurality of ribs 512, 512b and wedging apparatus 500. For example, in one embodiment, inner core 510 may be filled with a foam or a gas.

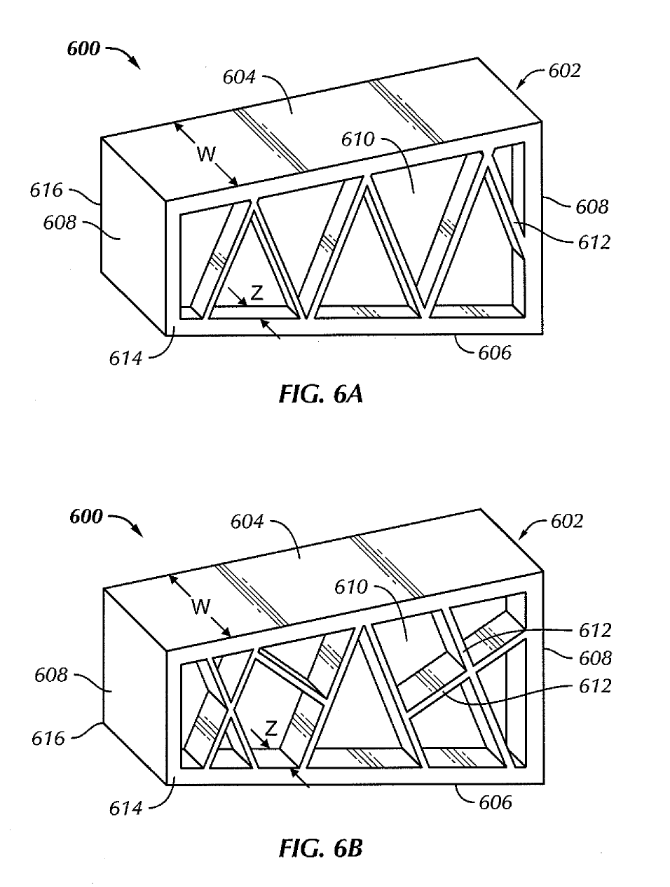

In another embodiment, as shown in FIGS. 6A and 6B, a wedging apparatus 600 may include an outer polygonal surface 602 having a top surface 604, a bottom surface 606, two end surfaces 608 that join top surface 604 and bottom surface 606, a first side 614, and a second side 616. Outer polygonal surface 602 defines an inner core 610 enclosed within top and bottom surfaces 604, 606, end surfaces 608, and first and second sides 614, 616. A plurality of ribs 612, 612b may be formed in first and/or second sides 614, 616. The plurality of ribs 612 may extend from top surface 604, bottom surface 606, or at least one end surface 608 and extend to the bottom surface 606, at least one end surface 608, or top surface 604. In another embodiment, the plurality of ribs 612b may also extend between a first rib and a second rib or between a first rib and top surface 604, bottom surface 606, or end surface 608.

In one embodiment, the plurality of ribs 612, 612b may extend a selected distance z from first side 614 into inner core 610 of wedging apparatus 600. For example, the plurality of ribs 612, 612b may extend half the width w of wedging apparatus 600. Alternatively, the plurality of ribs 612, 612b may extend along the entire width w of wedging apparatus 600, that is, ribs 612, 612b extend from first side 614 through wedging apparatus 600 to second side 616. In such an embodiment, distance z would be substantially the same a width w. One of ordinary skill in the art will appreciate that the ribs 612, 612b may extend any distance into wedging apparatus 600 such that the structural integrity of the wedging apparatus 600 is substantially maintained. In one embodiment, second side 616 may substantially enclose the wedging apparatus 600, while first side 614 includes a plurality of ribs 612, 612b, as described above. Cavities formed between each rib may be filled with any material known in the art, for example, a foam or gas. When placed in a shaker, the first side 614 of wedging apparatus 600 may be positioned proximate a wall of the basket and the enclosed second side 616 of wedging apparatus 600 may be positioned to face the inside of the basket. Thus, mud flowing over the shaker screen may not come into contact with first side 614, and therefore, inner core 610. Because drilling fluid or mud will not contact the material in the inner core 610, materials used to fill the cavities between the ribs of first side 614 may include materials with a lower chemical resistance.

In still other embodiments, a plurality of ribs 612, 612b may be formed on both the first and second sides 614, 616 of wedging apparatus 600 and extend back a selected distance z (as shown, z denotes the selected distance from first side 614, a selected distance is not independently illustrated for second side 616) into inner core 610, such that the plurality of ribs 612, 612b extending back from first side 614 do not contact the plurality of ribs 612, 612b extending back from second side 616. In one embodiment inner core 610 may include an additional cavity (not shown) formed between the two sets of ribs 612, 612b extending back from the first and second sides 614, 616. The cavity may be filled with any material known in the art, for example, a foam or gas. Alternatively, inner core 610 may be formed from a plastic as described below.

In the embodiments shown in FIGS. 6A and 6B, outer polygonal surface 602, including both first and second sides 614, 616, may be formed from any material known in the art. For example, outer polygonal surface 602 may be formed from a plastic, such as polyurethane, polypropolene, or nylon. In an alternate embodiment, the polygonal surface 602 may be formed from a composite material, such as glass-filled polypropolene. In one embodiment, inner core 610 may be integrally formed with outer polygonal surface 602. Accordingly inner core 610 may be formed from a plastic, such as polyurethane, polypropolene, or nylon, or a composite material, as described above. In an alternate embodiment, enclosed inner core 610 may be filled with a foam or gas.

In accordance with embodiments described above, a wedging apparatus may be formed by injection molding. In such an embodiment, a molten plastic is injected at a high pressure into a mold having an inverse shape of a desired wedging apparatus. The shape of the wedging apparatus may be, for example, any shape as detailed above and/or shown in FIGS. 3-6. The mold may be formed by a toolmaker or moldmaker from metal, typically either steel or aluminum, and precision-machined to form smaller, more detailed features. Once the mold is filled with molten plastic, the molten plastic is allowed to cure and is then removed from the mold. As detailed above, the mold may be filled with any molten plastic known in the art, for example, polyurethane, polypropolene, or nylon. In alternate embodiments, the mold may be filled with a molten composite material, such as glass-filled polypropolene. One of ordinary skill in the art will appreciate that other materials may be used without departing from the scope of embodiments disclosed herein.

Alternatively, a wedging apparatus in accordance with embodiments described above may be formed by gas-assist injection molding. In this embodiment, molten plastic is injected into a mold, partially filling it with a predetermined amount of resin or molten plastic. A gas, for example, nitrogen, is introduced into the mold cavity. The gas forms hollow channels as it follows a path of least resistance, thereby directing the molten plastic to fill all areas of the mold. As the gas expands in the cavity, forcing the molten plastic outward, all of the surfaces receive substantially equal pressure. The molten plastic is allowed to cure, the gas may be vented through a nozzle or vent, and the wedging apparatus may be removed from the mold.

FIGS. 6A and 6B show an example of a wedging apparatus 600 in accordance with the embodiments disclosed herein that may be formed by injection molding. In such an embodiment, molten plastic may be injected at pressure into the mold, wherein the molten plastic is allowed to cure, and the solid plastic wedging apparatus 600 is removed from the mold. The wedging apparatus 600, once removed, may be substantially solid with a plurality of ribs 612, 612b formed on the first and/or second sides 614, 616 of the wedging apparatus 600.

One of ordinary skill in the art will appreciate that any material known in the art may be used for both injection molding and gas-assist injection molding wedging apparatuses. In one embodiment, an outer polygonal surface of a wedging apparatus may be formed of any material with a low compression set and high impact performance. For example, an outer polygonal surface of a wedging apparatus may be formed of a plastic, such as polyurethane, polypropolene, or nylon, or a composite material, such as a glass-filled polypropolene. Further, an inner core of a wedging apparatus, defined by an outer polygonal surface, may be formed of or filled with any material known in the art. For example, an inner core of a wedging apparatus may be filled with a plastic, such as polyurethane, polypropolene, or nylon, or a composite material, such as a glass-filled polypropolene. Alternatively, an inner core of a wedging apparatus may be filled with a foam or gas. In embodiments where an inner core of a wedging apparatus is substantially enclosed, and therefore not in contact with drilling fluid flowing over a shaker screen, the inner core may be formed from or filled with a material of lower chemical resistance.

Advantageously, wedging apparatuses formed in accordance with embodiments disclosed herein may provide shortened cooling cycles, reduced surface warps, and increased structural stability. Advantageously, wedging apparatuses formed in accordance with embodiments disclosed herein may also be more cost efficient to manufacture. Moreover, wedging apparatuses formed in accordance with embodiments disclosed herein may be formed of more cost efficient materials, thereby providing more cost effective methods of forming wedging apparatuses.

Conventional wedges are often formed by open casting or compression molding. Injection molding a conventional wedge, having a basic wedge block structure, may result in warped edges due to the relative thickness of the wedge. Because the wedge is conventionally a solid piece of plastic, the molten plastic towards the middle of the wedge would cool much more slowly than the plastic towards the outer perimeter of the wedge, thereby causing the outer edges of the wedge to warp and deform out of shape. Advantageously, embodiments disclosed herein describe a wedging apparatus and a method of forming a wedging apparatus that may reduce the expenses of manufacturing and reduce the warp of the wedging apparatus during manufacturing, while maintaining the structural integrity of the wedging apparatus.

While the present disclosure has been described with respect to a limited number of embodiments, those skilled in the art, having benefit of this disclosure, will appreciate that other embodiments may be devised which do not depart from the scope of the present disclosure. Accordingly, the scope of the present disclosure should be limited only by the attached claims.

What is claimed:

1. A wedging apparatus comprising:
an outer polygonal surface configured to secure a screen to a shaker, the outer polygonal surface comprising a bottom surface, a top surface opposite the bottom surface, and at least one end surface joining the top surface and the bottom surface; and
an inner core defined by the outer polygonal surface,
wherein the inner core defines a cavity.

2. The wedging apparatus of claim 1, wherein the outer polygonal surface comprises a polyurethane or polypropolene.

3. The wedging apparatus of claim 1, wherein the inner core comprises polyurethane or polypropolene.

4. The wedging apparatus of claim 1, wherein the cavity of the inner core is filled with a foam.

5. The wedging apparatus of claim 1, wherein the inner core comprises a plurality of ribs.

6. The apparatus of claim 5, wherein the inner core further comprises a foam disposed between the plurality of ribs.

7. The wedging apparatus of claim 1, wherein the outer polygonal surface further comprises a first side and a second side, wherein the first side joins a first edge of the top surface and a first edge of the bottom surface, and the second side joins a second edge of the top surface and a second edge of the bottom surface.

8. The wedging apparatus of claim 7, wherein the inner core is substantially enclosed.

9. The wedging apparatus of claim 7, wherein the inner core comprises a plurality of ribs.

10. The wedging apparatus of claim 9, wherein the plurality of ribs extends into the inner core a selected distance from the first side.

11. The wedging apparatus of claim 9, wherein the plurality of ribs extends into the inner core a selected distances from the second side.

12. The wedging apparatus of claim 1, wherein the outer polygonal surface and the inner core of the wedging apparatus are formed by injection molding.

13. The wedging apparatus of claim 1, wherein the inner core is substantially enclosed by the outer polygonal surface.

14. A method of forming an apparatus for securing a screen to a shaker, the method comprising:
forming a mold of a wedging apparatus configured to secure a screen to a shaker, wherein a shape of the mold is an inverse of an outer polygonal surface comprising a bottom surface, a top surface opposite the bottom surface, and at least one end surface joining the top surface and the bottom surface, and an inner core defined by the outer polygonal surface, wherein the inner core defines a cavity;
injecting a liquid resin into the mold;
allowing the liquid resin to solidify; and
removing the wedging apparatus from the mold.

15. The method of claim 14, further comprising introducing a gas into the liquid resin in the mold.

16. The method of claim 14, wherein the liquid resin comprises polyurethane or polypropolene.

17. The method of claim 14, wherein the inner core comprises a plurality of ribs.

18. The method of claim 14, wherein the outer polygonal surface further comprises a first side and a second side, wherein the first side joins a first edge of the top surface and a first edge of the bottom surface, and the second side joins a second edge of the top surface and a second edge of the bottom surface.

19. The method of 14, further comprising filling the cavity defined by the inner core with a foam.

20. The method of claim 14, further comprising filling the cavity defined by the inner core with a gas.
